(19) United States
(12) Patent Application Publication
(10) Pub. No.: US 2024/0328335 A1
(43) Pub. Date: Oct. 3, 2024

(54) EXHAUST PURIFICATION DEVICE

(71) Applicant: HONDA MOTOR CO., LTD., Tokyo (JP)

(72) Inventors: Azusa TANAKA, Saitama (JP); Yuichi MATSUO, Saitama (JP); Yoshiyuki NAKANISHI, Saitama (JP)

(21) Appl. No.: 18/190,132

(22) Filed: Mar. 27, 2023

(51) Int. Cl. F01N 3/20; B01D 53/94; B01J 21/06; B01J 23/46; B01J 37/02; B01J 37/08

(52) U.S. Cl. CPC F01N 3/2026; B01D 53/9495; B01J 21/066; B01J 23/464; B01J 37/0225; B01J 37/08; B01D 2255/1025; B01D 2255/20715; B01D 2258/01; F01N 2330/02; F01N 2370/02

(57) ABSTRACT

Provided is an exhaust purification device which is provided in the exhaust passage of an internal combustion engine and purifies the exhaust gas of the internal combustion engine, the exhaust purification device including: a metal support having a flow path in which the exhaust gas flows; and a catalyst layer formed on a surface of the metal support, in which the catalyst layer includes a noble metal, and a metal having a different crystal structure than the noble metal.

### BACKGROUND OF THE INVENTION

### Field of the Invention

The present invention relates to an exhaust purification device.

### Related Art

Exhaust restrictions on automobiles are advancing further to reduce the negative impact on the global environment. For this reason, an exhaust purification device which purifies the exhaust gas is installed in the exhaust passage of an internal combustion engine such as a gasoline engine or diesel engine.

As the exhaust purification device, for example, a metal honeycomb catalyst has been known (for example, refer to Patent Document 1). Herein, the metal honeycomb catalyst is the finished article of a metal foil catalyst, and the metal foil catalyst includes metal foil and a catalyst layer provided on this metal foil. In addition, the catalyst layer contains a noble metal, and the thickness Ts (nm) of the metal foil and the thickness Tc (nm) of the catalyst layer satisfy Formula (1).

$$20 < Ts / Tc \qquad ( 1 )$$

Furthermore, the catalyst layer is formed on the metal foil by vapor depositing a catalyst layer formation material containing the noble metal by arc discharge.
Patent Document 1: PCT International Publication No. WO2017/033994

### SUMMARY OF THE INVENTION

However, when using the exhaust purification device disclosed in Patent Document 1 for a long period of time under the high temperature environment of an internal combustion engine, the exhaust purification performance declines. This is assumed to be due to the noble metal agglomerating, starting at the gap of the grain boundary generated by the crystals of noble metal growing, upon forming the catalyst layer.

The present invention has an object of providing an exhaust purification device capable of improving durability.

According to an aspect of the present invention, an exhaust purification device is provided in an exhaust passage of an internal combustion engine, and purifies exhaust gas of the internal combustion engine, the exhaust purification device including: a metal support having a flow path in which the exhaust gas flows; and a catalyst layer formed on a surface of the metal support, in which the catalyst layer includes a noble metal, and a metal having a different crystal structure than the noble metal.

The metal having a different crystal structure than the noble metal may have a melting point of 1700° C. or higher.

The noble metal may be rhodium, and the metal having a different crystal structure than the noble metal may be zirconium and/or tungsten.

The above-mentioned exhaust purification device may further include a zirconium layer between the metal support and the catalyst layer,

The catalyst layer may be formed by vacuum depositing the noble metal and the metal having a different crystal structure than the noble metal.

The above-mentioned exhaust purification device may further include an energizing part which energizes the metal support, in which the metal support may be able to be heated by way of energizing.

The catalyst layer may have a content of the metal having a different crystal structure than the noble metal of at least 5% by mass and no more than 55% by mass.

According to the present invention, it is possible to provide an exhaust purification device capable of improving durability.

### BRIEF DESCRIPTION OF THE DRAWINGS

FIG. 1 is a partial cross-sectional schematic diagram showing an example of an exhaust purification device according to the present embodiment;

FIG. 2 is a partial cross-sectional schematic diagram showing a modified example of the exhaust purification device in FIG. 1;

FIG. 3 is a graph showing evaluation results of a conversion rate of NO for the test pieces of Examples 1 and 2 and Comparative Example 1;

FIG. 4 is a graph showing evaluation results of a conversion rate of HC for the test pieces of Examples 1 and 2 and Comparative Example 1; and

FIG. 5 is a graph showing a relationship of the conversion rate of NO of a test piece relative to content of Zr in an Rh—Zr film.

### DETAILED DESCRIPTION OF THE INVENTION

Hereinafter, an embodiment of the present invention will be explained while referencing the drawings.

The exhaust purification device of the present embodiment is provided in an exhaust passage of an internal combustion engine, and purifies the exhaust gas of the internal combustion engine. Herein, the internal combustion engine can be exemplified by a gasoline engine or diesel engine, for example.

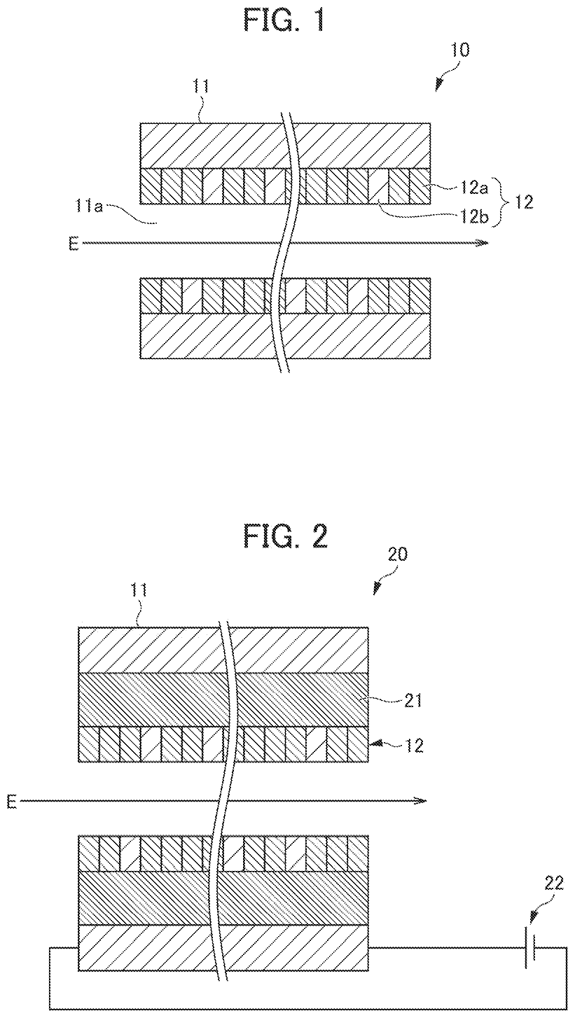

FIG. 1 shows a metal honeycomb catalyst as an example of the exhaust purification device of the present embodiment.

A metal honeycomb catalyst 10 includes: a metal support 11 having a flow path 11a in which exhaust gas E flows, and a catalyst layer 12 formed on the surface of the metal support 11. Herein, the catalyst layer 12 includes: a noble metal 12a, and a metal 12b having a different crystal structure than the noble metal 12a. For this reason, the durability of the metal honeycomb catalyst 10 improves. This is assumed to be due to agglomeration of the noble metal 12a being suppressed by the metal 12b having a different crystal structure than the noble metal 12a existing in the gap of the grain boundary generated by the crystal of noble metal 12a growing, upon forming the catalyst layer 12. At this time, the gap of the grain boundary serving as the starting point of agglomeration of the noble metal 12a decreases by the metal 12b, and migration of noble metal 12a accompanying agglomeration of the noble metal 12a is suppressed. In addition, the metal 12b does not form a solid solution with the noble metal 12a due to having a different crystal structure than the noble metal 12a.

The shape of the metal support 11 is not particularly limited; however, a circular column shape and elliptical column shape can be exemplified. In addition, the cross-sectional shape of the flow path 11a is not particularly limited; however, a triangular shape, square shape, hexagonal shape and octagonal shape can be exemplified.

The material constituting the metal support 11 is not particularly limited so long as being able to use under the high-temperature environment of an internal combustion engine; however, stainless steel can be exemplified, for example.

The thickness of the metal support 11 is not particularly limited; however, it is 10 μm or more and 100 μm or less.

The noble metal 12a is not particularly limited so long as able to purify exhaust gas; however, Pt, Pd and Rh (face-centered cubic lattice structure: fcc) can be exemplified. Thereamong, Rh is preferable in the point of exhaust purification performance of the metal honeycomb catalyst 10.

The metal 12b is not particularly limited so long as the crystal structure is differing from the noble metal 12a; however, W (melting point 3407° C.), Nb (2477° C.), Zr (1852° C.), Fe (1538° C.) (above, body-centered cubic lattice structure: bcc), Hf (2233° C.), Ti (1666° C.), Zn (419° C.) (above, hexagonal closest packing structure: hcp), etc. can be exemplified. Thereamong, Zr and/or W are preferable in the point of the durability of the metal honeycomb catalyst 10.

The melting point of the metal 12b is preferably at least 1700° C., and is more preferably at least 1800° C. When the melting point of the metal 12b is 1700° C. or higher, the durability of the metal honeycomb catalyst 10 improves. It should be noted that, although the melting point of the metal 12b is not particularly limited; however, it is no higher than 3500° C., for example.

The content of the metal 12b in the catalyst layer 12 is preferably at least 5% by mass and no more than 55% by mass. If the content of the metal 12b in the catalyst layer 12 is at least 5% by mass, the durability of the metal honeycomb catalyst 10 improves, and if no more than 55% by mass, the exhaust purification performance of the metal honeycomb catalyst 10 improves.

The thickness of the catalyst layer 12 is not particularly limited; however, it is at least 1 nm and no more than 1 μm, for example.

The metal honeycomb catalyst 10 can be produced, for example, by forming the catalyst layer 12 on a metal foil by vacuum depositing the noble metal 12a and metal 12b, followed by processing into a predetermined shape.

FIG. 2 shows a modified example of the metal honeycomb catalyst 10.

The metal honeycomb catalyst 20 is the same as the metal honeycomb catalyst 10 other than further including an intermediate layer 21 between the metal support 11 and catalyst layer 12, and further including the power source 22 as an energizing part that energizes the metal support 11. Herein, the intermediate layer 21 includes Zr, and the metal support 11 can be heated by energizing.

The metal honeycomb catalyst 20 includes the intermediate layer 21, and thus durability improves. In addition, the metal honeycomb catalyst 20 includes the power source 22, and thus can heat the metal support 11, a result of which the exhaust purification performance improves.

The thickness of the intermediate layer 21 is not particularly limited; however, it is at least 50 nm and no more than 1 μm.

The material capable of heating by energizing constituting the metal support 11 is not particularly limited; however, stainless steel can be exemplified.

Although an embodiment of the present invention has been explained above, the present invention is not limited to the above described embodiment, and the above embodiment may be modified where appropriate within the scope of the gist of the present invention.

### EXAMPLES

Examples of the present invention will be explained below; however, the present invention is not to be limited to the Examples. It should be noted that the test pieces corresponding to the exhaust purification device are used in the present examples, and the durability was evaluated.

### Example 1

A Zr film of 250 nm thickness and Rh—W film of 20 nm are formed on a stainless steel film of 40 μm thickness by vacuum deposition under conditions of 5.28×10⁸ to 5.92×10⁸ plasma density to obtain a test piece. At this time, vacuum deposition was done so that the content of W in the Rh—W film becomes 20% by mass.

### Example 2

Other than forming an Rh—Zr film in place of the Rh—W film, a test piece was obtained similarly to Example 1.

### Comparative Example 1

Other than forming an Rh film in place of the Rh—W film, a test piece was obtained similarly to Example 1.

### (Durability Treatment)

On the test piece, durability treatment for 20 hours at 980° C. was conducted while alternately switching between a lean atmosphere (20 seconds) and rich atmosphere (80 seconds).

### (Exhaust Purification Performance)

Using a catalyst reactor BELREA (manufactured by Microtrac BEL), the exhaust purification performances (conversion rates of NO and HC) of test pieces not subjected to durability treatment and test pieces subjected to durability treatment were evaluated. Herein, the composition of the model gas used upon evaluating the exhaust purification performance was NO (500 ppm), CO (5000 ppm), HC (propylene) (400 ppm), H₂O (10%), O₂ (4900 ppm), H₂ (1700 ppm), N₂ (balance), and the flowrate of model gas was set to 400 mL/min. In addition, before evaluating the exhaust purification performance, and after oxidizing the test pieces under an oxygen atmosphere at 500° C. for 15 minutes, pre-treatment reducing at 500° C. for 15 minutes under a hydrogen atmosphere was conducted.

It should be noted that the conversion rates of NO and HC are the average values of conversion rates at 300° C., 350° C., 400° C. and 450° C., respectively. In addition, the conversion rate of NO at each temperature was calculated by a formula:

[(inlet side NO concentration)−(outlet side NO concentration)]/(inlet side NO concentration)×100,

and the conversion rate of HC at each temperature was calculated by a formula:

$$[ ( inlet side HC concentration ) - ( outlet side HC concentration ) ] / ( inlet side HC concentration ) \times 100.$$

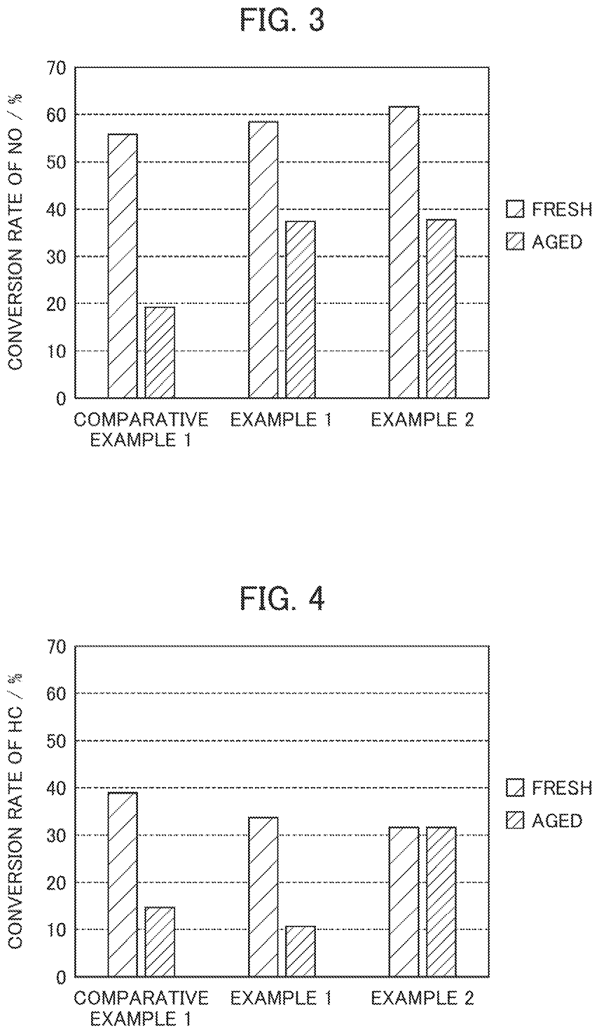

FIG. 3 shows evaluation results of the conversion rate of NO of the test pieces of Examples 1 and 2, and Comparative Example 1. In addition, FIG. 4 shows evaluation results of the conversion rate of HC of the test pieces of Examples 1 and 2, and Comparative Example 1.

It is understood from FIG. 3 that the test pieces of Examples 1 and 2 had a smaller decrease ratio in conversion rate of NO by the durability treatment, than the test piece of Comparative Example 1. It is understood from FIG. 4 that the test piece of Example 2 had smaller decrease ratio in conversion rate of HC by the durability treatment, than the test piece of Comparative Example 1. On the other hand, the test piece of Example 1 is equal to the test piece of Comparative Example 1 in the decrease ratio in conversion rate of HC by the durability treatment.

Therefore, the test pieces of Examples 1 and 2 are considered to have higher durability than the test piece of Comparative Example 1.

### (Simulation of Exhaust Purification Performance)

Using the NO conversion rate (refer to FIG. 3) of the test piece subjected to durability treatment of Example 2, test piece not subjected to durability treatment and the test piece subjected to durability treatment of Comparative Example 1, simulation of exhaust purification performance was conducted. More specifically, first, establishing the conversion rate of NO of the test piece not subjected to durability treatment of Comparative Example 1 (55%) as a reference, the coverage of Rh of the surface of the Rh—Zr film, i.e. conversion rate (y₀) of NO of test piece not subjected to durability treatment, decreases inversely proportional to the content of Zr (x) in the Rh—Zr film, and was assumed to become 0% when the content of Zr (x) in Rh—Zr film reaches 100% by mass (y₀=−0.55x+55). Herein, it was found that, for the conversion rate of NO of the test piece subjected to durability treatment of Comparative Example 1 (19.3%), the exhaust purification performance declined 64.9%, relative to the conversion rate of NO of the test piece not subjected to durability treatment of Comparative Example 1. On the other hand, it was found that, for the conversion rate of NO of the test piece subjected to durability treatment of Example 2 (37.9%), the exhaust purification performance declined 13.9% relative to the conversion rate of NO (y₀) of the test piece not subjected to durability treatment. Next, the effect of suppressing a decline in exhaust purification performance by Zr was assumed to be proportional to the content of Zr (x) in the Rh—Zr film. In other words, the decline ratio in exhaust purification performance (z) is represented by a formula:

$$z = 64.9 - ( 64.9 - 13.9 ) \times ( x / 20 ) .$$

However, the decline ratio in exhaust purification performance when the value of z is less than 0 is set to 0. Therefore, the conversion rate of NO (y) of the test piece subjected to durability treatment is represented by a formula:

$$y = {y}_{0} \times ( 1 - z ) .$$

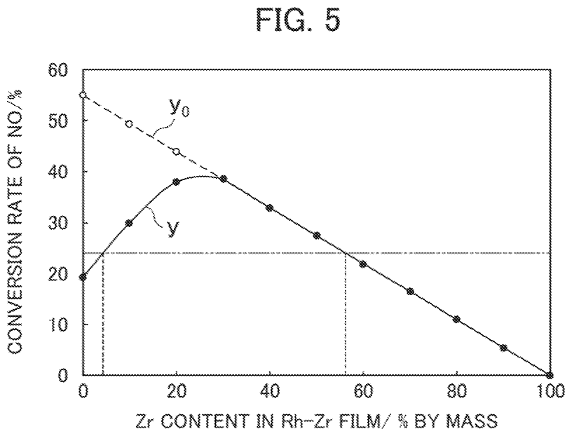

FIG. 5 shows the relationship of the conversion rate of NO of the test piece relative to the content of Zr in the Rh—Zr film.

From FIG. 5, it is predicted that the conversion rate of NO (y) of the test piece subjected to durability treatment will be higher when the content of Zr in the Rh—Zr film is at least 5% by mass and no more than 55% by mass.

### EXPLANATION OF REFERENCE NUMERALS

10, 20 metal honeycomb catalyst
11 metal support
11a flow path
12 catalyst layer
12a noble metal
12b metal
21 intermediate layer
22 power source
E exhaust gas

What is claimed is:

1. An exhaust purification device which is provided in an exhaust passage of an internal combustion engine, and purifies exhaust gas of the internal combustion engine, the exhaust purification device comprising:
a metal support having a flow path in which the exhaust gas flows; and
a catalyst layer formed on a surface of the metal support,
wherein the catalyst layer includes a noble metal, and a metal having a different crystal structure than the noble metal.

2. The exhaust purification device according to claim 1, wherein the metal having a different crystal structure than the noble metal has a melting point of 1700° C. or higher.

3. The exhaust purification device according to claim 1, wherein the noble metal is rhodium, and
wherein the metal having a different crystal structure than the noble metal is zirconium and/or tungsten.

4. The exhaust purification device according to claim 1, further comprising an intermediate layer between the metal support and the catalyst layer,
wherein the intermediate layer contains zirconium.

5. The exhaust purification device according to claim 1, wherein the catalyst layer is formed by vacuum depositing the noble metal and the metal having a different crystal structure than the noble metal.

6. The exhaust purification device according to claim 1, further comprising an energizing part which energizes the metal support,
wherein the metal support can be heated by way of energizing.

7. The exhaust purification device according to claim 1, wherein the catalyst layer has a content of the metal having a different crystal structure than the noble metal of at least 5% by mass and no more than 55% by mass.
